(19) United States
(12) Patent Application Publication
(10) Pub. No.: US 2026/0099570 A1
(43) Pub. Date: Apr. 9, 2026

(54) CASCADE EFFECT EVALUATION METHOD AND SYSTEM OF LOCAL ENERGY SCARCITY RISKS BASED ON BETWEENNESSS ALGORITHM

(71) Applicant: Beijing Normal University, Beijing (CN)

(72) Inventors: Hui LI, Beijing (CN); Hanlei WANG, Beijing (CN); Yulei XIE, Beijing (CN); Gengyuan LIU, Beijing (CN); Zhifeng YANG, Beijing (CN)

(73) Assignee: Beijing Normal University, Beijing (CN)

(21) Appl. No.: 19/417,234

(22) Filed: Dec. 11, 2025

(30) Foreign Application Priority Data
Dec. 18, 2024 (CN) 202411871683.8

(51) Int. Cl. G06F 17/18; G06F 17/16; G06Q 50/06

(52) U.S. Cl. CPC G06F 17/18; G06F 17/16; G06Q 50/06

(57) ABSTRACT

The invention discloses a cascade effect evaluation method and system for evaluating local energy scarcity risks based on a Betweennesss algorithm, which involves the field of energy resource management. The method includes steps of obtaining an energy pressure index of each region and an energy dependence of each sector, and an energy scarcity probability is calculated according to the energy pressure index. The initial energy scarcity risk is then combined with a multi-regional input-output model to construct a virtual energy scarcity risk transmission network. Based on the Betweenness algorithm, the key transmission nodes of the cascade effect of local energy scarcity risk are evaluated and identified in the virtual energy scarcity risk transmission network. The invention has a wide application range and efficient calculation method, and can provide an effective method for improving the resilience of trade networks to cope with the risk of energy scarcity.

### TECHNICAL FIELD

The invention relates to the field of energy resource management, especially a cascade effect evaluation method and system of local energy scarcity risks based on a Betweennesss algorithm.

### BACKGROUND

Energy scarcity not only directly impacts the economies of certain sectors in regions but can also propagate risks to others through supply chains, leading to systemic vulnerabilities. That is, the initial risk produces a cascade effect, inflicting indirect economic losses on the downstream sector in regions and amplifying both the complexity and scope of the risk.

Previous studies have largely focused on the start and end points of risk transmission, without delving into the identification of key sectors that facilitate risk propagation along the pathway. Identifying these critical transmission sectors is essential for enabling early intervention in the risk diffusion process.

The Betweenness method is commonly used to measure node centrality in networks. The transmission of energy scarcity risk within the socio-economic system can be conceptualized as a directed weighted complex network. By applying the Betweenness method to deconstruct the risk network's structure and identify pivotal transmission nodes, we can pinpoint new leverage points for enhancing the resilience of the socio-economic system against energy scarcity risks.

Therefore, in the context of today's highly interconnected global economy, there is an urgent need for a cascade effect evaluation method for local energy scarcity risks based on the Betweennesss algorithm.

### SUMMARY

In order to solve the above problems, this application proposes a cascade effect evaluation method for local energy scarcity risks based on the Betweennesss algorithm. By systematically pinpointing all key nodes through which local energy scarcity risk propagates along the supply chain, more effective strategies can be formulated to enhance the resilience of the entire trade network. In particular, identifying key intermediaries allows for early intervention in the risk cascade, thereby mitigating more severe downstream impacts.

The cascade effect evaluation method for local energy scarcity risks based on a Betweennesss algorithm includes the following steps:
S1, obtaining an energy pressure index of each region and an energy dependence of each sector, calculating an energy scarcity probability according to the energy pressure index, and calculating an initial energy scarcity risk according to the energy scarcity probability and the energy dependence of each sector;
S2, combining the initial energy scarcity risk with a multi-regional input-output model to construct a virtual energy scarcity risk transmission network;
S3, based on a Betweenness algorithm, evaluating and identifying a key transmission node of a cascade effect of local energy scarcity risks in the virtual energy scarcity risk transmission network.

In some embodiments, an expression for calculating the energy pressure index is:

$$E P {I}_{i} = \frac{{\sum }_{k = 1}^{h} {CE}_{i}^{k}}{{\sum }_{k = 1}^{h} {SE}_{i}^{k}}$$

where

$${SE}_{i}^{k} = {DE}_{i}^{k} + {IME}_{i}^{k} - {EXE}_{i}^{k} ,$$

EPIᵢ denotes an energy pressure index of region i,

$${SE}_{i}^{k}$$

denotes a supply of a k-th energy in region i,

$${CE}_{i}^{k}$$

denotes a consumption of the k-th energy in region i, 1≤k≤h, h denotes an energy type,

$${DE}_{i}^{k}$$

denotes a production of the k-th energy in region i,

$${ME}_{i}^{k}$$

denotes an import of the k-th energy in region i, and

$${EXE}_{i}^{k}$$

denotes an export of the k-th energy in region i.

In some embodiments, an expression of energy scarcity probability is:

$${ESP}_{i} = {f}_{ESP} ( {EPI}_{i} ; σ ) = E ( {Y}_{i} ) ;$$

$$where {Y}_{i} = \{ \begin{matrix}0 & {X}_{i} \geq 1 \\ 1 - {X}_{i} & {X}_{i} < 1\end{matrix} \} , {X}_{i} ∼ Log normal ( {μ}_{i} , {σ}^{2} ) , {μ}_{i} = log \frac{1}{{EPI}_{i}} , {ESP}_{i}$$

denotes an energy scarcity probability in region i, E(Yᵢ) denotes an expected value of Yᵢ, Yᵢ denotes an energy scarcity in region i on each space-time unit, Xᵢ obeys a lognormal distribution, and denotes a ratio of energy supply and consumption in region i within each space-time unit, μᵢ is a variance, parameter σ is a standard deviation, equal to 1.

In some embodiments, an expression of energy dependence of each sector is:

$$E D {L}_{m , i} = {f}_{E D L} ( E {l}_{m , i} ; α ) = \frac{1}{1 + {e}^{- α {EI}_{m , i}^{i n t}} ( \frac{1}{0.001} - 1 )}$$

where

$${EI}_{m , i} = \frac{{\sum }_{k = 1}^{10} {EC}_{m , i}^{k}}{{x}_{m , i}} ,$$

EDL_{m,i} denotes an energy dependence of sector m in region i,

$${EC}_{m , i}^{k}$$

denotes a consumption of the k-th energy of sector m in region i, and EI_{m,i} denotes an energy consumption intensity of sector m in region i, EI_{m,i} is equal to a sum

$${\sum }_{k = 1}^{10} {EC}_{m , i}^{k}$$

of 10 energy consumptions of sector m in region i divided by a total output x_{m,i}, α is a cut-off parameter of ED_{m,i}, a value is set to 2.

In some embodiments, an expression of the initial energy scarcity risk is:

$${IESR}_{m , i} = {ESP}_{i} \times {EDL}_{m , i} \times {x}_{m , i}$$

where IESR_{m,i} denotes an initial energy scarcity risk of sector m in region i; ESPᵢ denotes an energy scarcity probability in region i; EDL_{m,i} denotes an energy dependence of sector m in region i; x_{m,i} denotes a total output of sector m in region i.

In some embodiments, combining the initial energy scarcity risk with the multi-regional input-output model to construct the virtual energy scarcity risk transmission network, specifically including:
an expression of using a Ghosh inverse matrix to evaluate a spread of virtual energy scarcity risks is:

$$U = {\hat{E} ( I - B )}^{- 1} ;$$

where U denotes a propagation matrix of the virtual energy scarcity risks, in which element

$${u}_{m , i}^{n , j}$$

denotes a cascade effect of sector m in region i on sector n in region j;
E is a row vector, where each element denotes the initial energy scarcity risk of each sector in each region, and expression Ê is a process of diagonalization of vector E;
matrix (I−B)⁻¹ is usually called the Ghosh inverse matrix, element

$${g}_{m , i}^{n , j}$$

denotes an output quantity of sector n in region j caused by an accumulation of unit products produced by sector m in region i, B denotes a direct output coefficient matrix in the multi-regional input-output model, and i denotes a unit matrix;
after Taylor expansion of the Ghosh inverse matrix, the energy scarcity risk is decomposed into different production levels:

$$G = {( I - B )}^{- 1} = I + B + {B}^{2} + {B}^{3} + … ;$$

$$U = \hat{E} ( I + B + {B}^{2} + {B}^{3} + … ) = \hat{E} I + \hat{E} B + \hat{E} {B}^{2} + \hat{E} {B}^{3} + … ;$$

a supply chain path starts from sector m in region i, passes through (r₁, r₂, . . . rₖ) of sector k, and ends in sector q in this region, an expression of the cascade effect generated by the path is:

$$P ( m , \vert q \vert {r}_{1} , {r}_{2} , ⋯ {r}_{k} ) = {E}_{m , i} {b}_{{mr}_{1}} {b}_{{r}_{1} {r}_{2}} ⋯ {b}_{{r}_{k} q} ;$$

where P(m, |q|r₁, r₂, . . . rₖ) denotes a weight of supply chain path (m→r₁→r₂→ . . . →rₖ→q);
E_{m,i} denotes the initial energy scarcity risk in sector m in region i;
element bₘᵣ_{₁}bᵣ_{₁}ᵣ_{₂} . . . bᵣ_{ₖ}_{q} belongs to the elements in matrix B;
the virtual energy scarcity risk transmission network is composed of supply chain paths.

In some embodiments, based on the Betweenness algorithm, evaluating and identifying the key transmission node of the cascade effect of local energy scarcity risks in the virtual energy scarcity risk transmission network, specifically including:

$${b}_{i} = {\sum }_{m = 1}^{n} {\sum }_{q = 1}^{n} {\sum }_{k = 1}^{∞} ( {t}_{k} P ( m , \vert q \vert {r}_{1} , {r}_{2} , ⋯ {r}_{k} ) )$$

where bᵢ denotes a Betweenness of sector i;
n denotes a number of sectors in the virtual energy scarcity risk transmission network;
tₖ denotes an occurrence time of sector i between the two ends of the supply chain path (m→r₁→r₂→ . . . rₖ→q);
a total weight of the supply chain path through sector i is defined as bᵢ(l₁, l₂), and an expression of bᵢ(l₁,l₂) is:

$$\begin{matrix}{b}_{i} ( {l}_{1} , {l}_{2} ) & = {\sum }_{1 \leq {r}_{1} , ⋯ {r}_{{l}_{1}} \leq n} {\sum }_{1 \leq {j}_{1} , ⋯ {j}_{l 2} \leq n} ( {E}_{{r}_{1}} {b}_{{r}_{1} {r}_{2}} ⋯ {b}_{{r}_{{l}_{1}} i} {b}_{{ij}_{1}} … {b}_{{j}_{{l}_{2} - 1} {j}_{{l}_{2}}} ) \\ & = {\sum }_{1 \leq {r}_{1} , ⋯ {r}_{{l}_{1}} \leq n} ( {E}_{{r}_{1}} {b}_{{r}_{1} {r}_{2}} ⋯ {b}_{{r}_{{l}_{1}} i} {\sum }_{1 \leq {j}_{1} , ⋯ {j}_{l 2} \leq n} ( {b}_{{ij}_{1}} … {b}_{{j}_{{l}_{2} - 1} {j}_{{l}_{2}}} ) ) \\ & = ( {\sum }_{1 \leq {r}_{1} , ⋯ {r}_{{l}_{1}} \leq n} ( {E}_{{r}_{1}} {b}_{{r}_{1} {r}_{2}} ⋯ {b}_{{r}_{{l}_{1}} i} ) ) ( {\sum }_{1 \leq {j}_{1} , ⋯ {j}_{l 2} \leq n} ( {b}_{{ij}_{1}} … {b}_{{j}_{{l}_{2} - 1} {j}_{{l}_{2}}} ) ) \\ & = {( {EB}^{{l}_{1}} )}_{i} {( {B}^{{l}_{2}} e )}_{i} \\ & = {EB}^{{l}_{1}} {J}_{i} {B}^{{l}_{2}} e\end{matrix}$$

where l₁ denotes a number of upstream sectors of sector i, l₂ denotes a number of downstream sectors of sector i. l₁ and l₂ are all integers greater than or equal to 1;
Jᵢ denotes a matrix that being 1 at element (i,i) and being 1 at other elements;
e denotes a unit column vector e with a size of n×1, all elements of e are equal to 1;
T=GB=BG=B+B²+B³+ . . . , a Betweenness expression of sector i is:

$$\begin{matrix}{b}_{i} & = {\sum }_{{l}_{1} = 1}^{∞} {\sum }_{{l}_{2} = 1}^{∞} {b}_{i} ( {l}_{1} , {l}_{2} ) = {\sum }_{{l}_{1} = 1}^{∞} {\sum }_{{l}_{2} = 1}^{∞} ( {EB}^{{l}_{1}} {J}_{i} {B}^{{l}_{2}} e ) \\ & = {\sum }_{{l}_{1} = 1}^{∞} ( {EB}^{{l}_{1}} {J}_{i} {\sum }_{{l}_{2} = 1}^{∞} ( {B}^{{l}_{2}} e ) ) \\ & = ( {\sum }_{{l}_{1} = 1}^{∞} ( {EB}^{{l}_{1}} ) ) {J}_{i} ( {\sum }_{{l}_{2} = 1}^{∞} ( {B}^{{l}_{2}} e ) ) \\ & = E ( {\sum }_{{l}_{1} = 1}^{∞} {B}^{{l}_{1}} ) {J}_{i} ( {\sum }_{{l}_{2} = 1}^{∞} {B}^{{l}_{2}} ) e \\ & = {ETJ}_{i} Te\end{matrix}$$

where n×n matrix T=GB is composed of the Ghosh inverse matrix G and the direct output coefficient matrix B, element tᵢⱼ in the matrix denotes a direct and indirect output of sector j generated by a single output of sector i;
the Betweenness values bᵢ of all nodes are summed and averaged to obtain the mean b̅:

$$\overline{b} = \frac{{\sum }_{i = 1}^{n} {b}_{i}}{n}$$

where n denotes a total number of nodes in the network;
through a mean multiple method, screening threshold T of key nodes is set, that is, a multiple of b̅: T=λ·b̅
where λ denotes a multiple factor, it is set to 2;
the Betweenness value and the threshold value of each sector in regional nodes are compared. If a node has a Betweenness value bᵢ≥T, it is determined to be the key transmission node of cascade effect of the local energy scarcity risk.

A cascade effect evaluation system for local energy scarcity risks based on a Betweenness algorithm, including a data acquisition module, an energy scarcity risk transmission network acquisition module and a cascade effect evaluation module;
where the data acquisition module includes an energy pressure index acquisition unit, an energy scarcity probability acquisition unit, an energy dependence acquisition unit, and an initial energy scarcity risk acquisition unit;
the energy pressure index acquisition unit is configured to calculate the energy pressure index of each region;
the energy scarcity probability acquisition unit is configured to calculate the energy scarcity probability of each region;
the energy dependence acquisition unit is configured to calculate the energy dependence based on various sectors in each region;
the initial energy scarcity risk acquisition unit is configured to calculate the energy scarcity risk of each sector in each region;
the virtual energy scarcity risk transmission network acquisition module is configured to build a virtual energy scarcity risk transmission network;
the cascade effect evaluation module is configured to determine the key transmission nodes of the cascade effect of local energy scarcity risks based on the Betweenness algorithm.

An electronic device, including a memory, a processor, and a computer program stored in the memory and capable of running on the processor, implements the cascade effect evaluation method for the local energy scarcity risks when the processor executes the computer program.

A computer readable storage medium, the computer readable storage medium stores a computer program, when the computer program is executed by the processor, the cascade effect evaluation method for the energy scarcity risks is realized.

In summary, the present disclosure provides a cascade effect evaluation method for local energy scarcity risks based on a Betweennesss algorithm, compared with traditional technology, the present disclosure provides a method for calculating the energy scarcity risks. By constructing a virtual energy scarcity risk transmission network, this study proposes a methodology to evaluate the cascade effects of local energy scarcity risks. This approach helps identify all key nodes of virtual energy scarcity risk across the supply chain, thereby enhancing the resilience of the overall trade network in response to energy shortages.

The study introduces a monetization index for initial energy scarcity risk and provides an in-depth analysis of its cascade effects from a supply chain perspective. Through the construction of a virtual energy scarcity risk transmission network, critical nodes of risk propagation within the supply chain are pinpointed. This not only helps prevent fluctuations at any single node from spreading to upstream and downstream regions and sectors, but also effectively mitigates systemic risks induced by energy scarcity.

With its broad applicability and computationally efficient methodology, this research fills an important gap in the existing literature and offers effective methodological and data support for strengthening the resilience of trade networks against energy scarcity risks.

The following is a further detailed description of the technical method of the invention through drawings and implementation examples.

### BRIEF DESCRIPTION OF THE DRAWINGS

FIG. 1 is a procedure chart of the cascade effect evaluation method for local energy scarcity risks based on a Betweennesss algorithm.

FIG. 2 is a schematic diagram of the cascade effect evaluation system of local energy scarcity risks based on a Betweennesss algorithm.

### DETAILED DESCRIPTION OF THE EMBODIMENTS

The technical methodology of the present invention is further explained below with reference to the accompanying drawings and specific implementation examples. Unless otherwise specified, the relative arrangements, numerical expressions, and values of components and steps described in these examples shall not be construed as limiting the scope of the application.

The following description of at least one exemplary embodiment is intended to be illustrative only and in no way serves to limit the application or its use.

Technologies, systems, and equipment known to those of ordinary skill in the relevant technical field may not be discussed in detail; however, where appropriate, they are considered part of the specification.

In all examples shown and discussed herein, any specific value should be interpreted as illustrative only and not as restrictive. Accordingly, other exemplary embodiments may have different values.

Unless otherwise defined, technical and scientific terms used in this invention shall carry the meaning commonly understood by a person skilled in the art to which this invention belongs.

The main purpose of the invention is to solve some defects existing in the existing image compression technology, especially when compressing images in machine vision applications, the relationship between the volume after image compression and the retention of effective visual data information of the image is not fully considered, and then the image is compressed according to a fixed compression ratio, resulting in the loss of effective visual information after image compression.

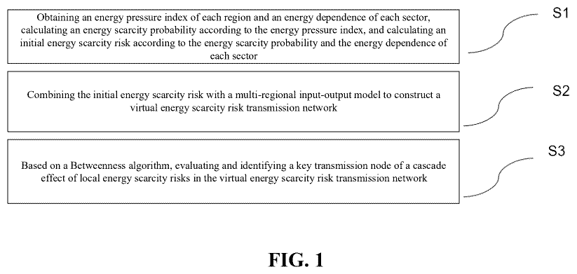

As shown in FIG. 1, the invention provides a cascade effect evaluation method for local energy scarcity risks based on a Betweennesss algorithm, including the following steps:
S1, the energy pressure index of each region and the energy dependence of each sector are obtained, the energy scarcity probability is calculated according to the energy pressure index, and the initial energy scarcity risk is calculated according to the energy scarcity probability and the energy dependence of each sector;

In some embodiments, the expression for calculating the energy pressure index is:

$$E P {I}_{i} = \frac{{\sum }_{k = 1}^{h} {CE}_{i}^{k}}{{\sum }_{k = 1}^{h} {SE}_{i}^{k}} ;$$

where

$${SE}_{i}^{k} = {DE}_{i}^{k} + {IME}_{i}^{k} - {EXE}_{i}^{k} ,$$

EPIᵢ denotes the energy pressure index of region i,

$${SE}_{i}^{k}$$

denotes the supply of a k-th energy in region i,

$${CE}_{i}^{k}$$

denotes the consumption of the k-th energy in region i, 1≤k≤h, h denotes the energy type,

$${DE}_{i}^{k}$$

denotes the production of the k-th energy in region i,

$${ME}_{i}^{k}$$

denotes the import of the k-th energy in region, and

$${EXE}_{i}^{k}$$

denotes the production of the k-th energy in region i.

The energy type h covered in this step is limited to ten categories: coal, coke, crude oil, gasoline, kerosene, diesel fuel, fuel oil, liquefied petroleum gas, natural gas, and electricity.

In some embodiments, the expression of energy scarcity probability is:

$$E S {P}_{i} = {f}_{ESP} ( E P {I}_{i} ; σ ) = E ( {Y}_{i} ) ;$$

$$where {Y}_{i} = \{ \begin{matrix}0 , & {X}_{i} \geq 1 \\ 1 - {X}_{i} & {X}_{i} < 1\end{matrix} \} , {X}_{i} ∼ Lognormal ( {μ}_{i} , {σ}^{2} ) , {μ}_{i} = log \frac{1}{E P {I}_{i}} , E S {P}_{i}$$

denotes the energy scarcity probability in region i, E(Yᵢ) denotes the expected value of Yᵢ, Yᵢ denotes the energy scarcity in region i on each space-time unit, Xᵢ obeys the lognormal distribution and denotes the ratio of energy supply and consumption in region i within each space-time unit, μᵢ is a variance of Xᵢ, variance μᵢ is a logarithm of

$$\frac{1}{E P {I}_{i}} ,$$

parameter σ is a standard deviation, equal to 1.

In some embodiments, an expression of energy dependence of each sector is:

$${EDL}_{m , i} = {f}_{EDL} ( {EI}_{m , i} ; α ) = \frac{1}{1 + {e}^{- α {EI}_{m , i}^{int}} ( \frac{1}{0.001} - 1 )}$$

where

$${EI}_{m , i} = \frac{{\sum }_{k = 1}^{10} {EC}_{m , i}^{k}}{{x}_{m , i}} ,$$

EDL_{m,i} denotes the energy dependence of sector m in region i,

$${EC}_{m , i}^{k}$$

denotes the consumption or the k-th energy of sector m in region i, and EI_{m,i} denotes the energy consumption intensity of sector m in region i, EI_{m,i} is equal to the sum

$${\sum }_{k = 1}^{10} {EC}_{m , i}^{k}$$

or 10 energy consumptions of sector m in region i divided by a total output x_{m,i}, α is the cut-off parameter of ED_{m,i}, the value is set to 2.

In some embodiments, the expression of the initial energy scarcity risk is:

$${IESR}_{m , i} = {ESP}_{i} \times {EDL}_{m , i} \times {x}_{m , i}$$

where IESR_{m,i} denotes the initial energy scarcity risk of sector m in region i; ESPᵢ denotes the energy scarcity probability in region i; EDL_{m,i} denotes the energy dependence of sector m in region i; x_{m,i} denotes the total output of sector m in region i.
S2, the initial energy scarcity risk is combined with a multi-regional input-output model to construct a virtual energy scarcity risk transmission network;

In some embodiments, the specific content of constructing a virtual energy scarcity risk transmission network by combining the initial energy scarcity risk with the multi-regional input-output model is as follows:

It is assumed that an economic system includes n production sectors, the 1×n row vector v denotes the initial input of each sector, the n×n matrix Z denotes the inter-sectoral product transaction, the n×1 column vector x denotes the total input of each sector, and all elements of the n×1 column vector e are 1. The column equilibrium expression of the input-output model is:

$$x = eZ + v ;$$

Defining a n×n matrix B as B=(\hat{x})⁻¹×Z, where the sign “\hat{ }” denotes that the vector is transformed into a diagonal matrix, and the sign “−1” denotes the inverse of the matrix. Matrix B is the direct output coefficient matrix, and its element bᵢⱼ indicates that the direct output of sector j is generated by sector i producing one unit output. The transformation of the column equilibrium expression of the input-output model is:

$$x = {v ( I - B )}^{- 1} ;$$

the transformation of the column equilibrium expression of the input-output model establishes the correlation between the total output x and the initial input v. The matrix (I−B)⁻¹ is a Ghosh inverse matrix, and its element gᵢⱼ denotes the output of sector j caused by the accumulation (including direct and indirect) of the unit product produced by sector i.

We use the Ghosh inverse matrix to evaluate the spread of virtual energy scarcity risk. The expression of using the Ghosh inverse matrix to evaluate the spread of virtual energy scarcity risk is:

$$U = {\hat{E} ( I - B )}^{- 1} ;$$

where U denotes the propagation matrix of the virtual energy scarcity risks, in which element

$${u}_{m , i}^{n , j}$$

denotes the cascade effect of sector m in region i on sector n in region j;
E is the row vector, where each element denotes the initial energy scarcity risk of each sector in each region, and expression Ê is the process of diagonalization of vector E;
matrix (I−B)⁻¹ is usually called the Ghosh inverse matrix, element

$${g}_{m , i}^{n , j}$$

denotes the output quantity of sector n in region j caused by the accumulation of unit products produced by sector m in region i, B denotes the direct output coefficient matrix in the multi-regional input-output model, and I denotes the unit matrix;

after Taylor expansion of the Ghosh inverse matrix, the energy scarcity risk is decomposed into different production levels:

$$G = {( I - B )}^{- 1} = I + B + {B}^{2} + {B}^{3} + … ;$$

$$U = \hat{E} ( I + B + {B}^{2} + {B}^{3} + … ) = \hat{E} I + \hat{E} B + \hat{E} {B}^{2} + \hat{E} {B}^{3} + … ;$$

the supply chain path starts from sector m in region i, passes through (r₁, r₂, . . . rₖ) of sector k, and ends in sector q in this region, the expression of the cascade effect generated by the path is:

$$P ( m , \vert q \vert {r}_{1} , {r}_{2} , … {r}_{k} ) = {E}_{m , i} {b}_{{mr}_{1}} {b}_{{r}_{1} {r}_{2}} … {b}_{{r}_{k} q} ;$$

where P(m, |q|r₁, r₂, . . . rₖ) denotes the weight of supply chain path (m→r₁→r₂→ . . . rₖ→q);
E_{m,i} denotes the initial energy scarcity risk in sector m in region i;
element bₘᵣ_{₁}bᵣ_{₁}ᵣ_{₂} . . . bᵣ_{ₖ}_{q} belongs to the elements in matrix B;
the virtual energy scarcity risk transmission network is composed of supply chain paths.
S3, based on the Betweenness algorithm, the key transmission node of the cascade effect of local energy scarcity risks in the virtual energy scarcity risk transmission network is evaluated and identified.

In some embodiments, based on the Betweenness algorithm, evaluating and identifying the key transmission node of the cascade effect of local energy scarcity risks in the virtual energy scarcity risk transmission network, specifically including:

$${b}_{i} = {\sum }_{m = 1}^{n} {\sum }_{q = 1}^{n} {\sum }_{k = 1}^{∞} ( {t}_{k} P ( m , \vert q \vert {r}_{1} , {r}_{2} , … {r}_{k} ) )$$

where bᵢ denotes the Betweenness of sector i;
n denotes the number of sectors in the virtual energy scarcity risk transmission network;
tₖ denotes the occurrence time of sector i between the two ends of the supply chain path (m→r₁→r₂→ . . . →rₖ→q);
the total weight of the supply chain path through sector i is defined as bᵢ(l₁, l₂), and an expression of bᵢ(l₁, l₂) is:

$$\begin{matrix}{b}_{i} ( {l}_{1} , {l}_{2} ) = {\sum }_{1 \leq {r}_{1} , … {r}_{{l}_{1}} \leq n} {\sum }_{1 \leq {j}_{1} , … {j}_{l 2} \leq n} ( {E}_{{r}_{1}} {b}_{{r}_{1} {r}_{2}} … {b}_{{r}_{{l}_{1} i}} {b}_{{ij}_{1}} … {b}_{{j}_{{l}_{2} - 1} {j}_{{l}_{2}}} ) \\ = {\sum }_{1 \leq {r}_{1} , … {r}_{{l}_{1}} \leq n} ( {E}_{{r}_{1}} {b}_{{r}_{1} {r}_{2}} … {b}_{{r}_{{l}_{1}} i} {\sum }_{1 \leq {j}_{1} , … {j}_{l 2} \leq n} ( {b}_{{ij}_{1}} … {b}_{{j}_{{l}_{2} - 1} {j}_{{l}_{2}}} ) ) \\ = ( {\sum }_{1 \leq {r}_{1} , … {r}_{{l}_{1}} \leq n} ( {E}_{{r}_{1}} {b}_{{r}_{1} {r}_{2}} … {b}_{{r}_{{l}_{1}} i} ) ) ( {\sum }_{1 \leq {j}_{1} , … {j}_{l 2} \leq n} ( {b}_{{ij}_{1}} … {b}_{{j}_{{l}_{2} - 1} {j}_{{l}_{2}}} ) ) \\ = {( {EB}^{{l}_{1}} )}_{i} {( {B}^{{l}_{2}} e )}_{i} \\ = {EB}^{{l}_{1}} {J}_{i} {B}^{{l}_{2}} e\end{matrix}$$

where l₁ denotes the number of upstream sectors of sector i, l₂ denotes the number of downstream sectors of sector i. l₁ and l₂ are all integers greater than or equal to 1;
Jᵢ denotes the matrix that being 1 at element (i,i) and being 1 at other elements;
e denotes the unit column vector e with a size of n×1, all elements of e are equal to 1;

T=GB=BG=B+B²+B³+ . . . , the Betweenness expression of sector i is:

$${b}_{i} = {\sum }_{{l}_{1} = 1}^{∞} {\sum }_{{l}_{2} = 1}^{∞} {b}_{i} ( {l}_{1} , {l}_{2} ) = {\sum }_{{l}_{1} = 1}^{∞} {\sum }_{{l}_{2} = 1}^{∞} ( {EB}^{{l}_{1}} {J}_{i} {B}^{{l}_{2}} e ) = {\sum }_{{l}_{1} = 1}^{∞} ( {EB}^{{l}_{1}} {J}_{i} {\sum }_{{l}_{2} = 1}^{∞} ( {B}^{{l}_{2}} e ) ) = ( {\sum }_{{l}_{1} = 1}^{∞} ( {EB}^{{l}_{1}} ) ) {J}_{i} ( {\sum }_{{l}_{2} = 1}^{∞} ( {B}^{{l}_{2}} e ) ) = E ( {\sum }_{{l}_{1} = 1}^{∞} {B}^{{l}_{1}} ) {J}_{i} ( {\sum }_{{l}_{2} = 1}^{∞} {B}^{{l}_{2}} ) e$$

where n×n matrix T=GB is composed of the Ghosh inverse matrix G and the direct output coefficient matrix B, element tᵢⱼ in the matrix denotes the direct and indirect output of sector j generated by the single output of sector i;
the Betweenness values bᵢ of all nodes are summed and averaged to obtain the mean b̅:

$$\overline{b} = \frac{{\sum }_{i = 1}^{n} {b}_{i}}{n}$$

where n denotes the total number of nodes in the network;
through a mean multiple method, screening threshold T of key nodes is set, that is, a multiple of b̅: T=λ·b̅
where λ denotes the multiple factor, it is set to 2;
the Betweenness value and the threshold value of each sector in regional nodes are compared. If the node has a Betweenness value bᵢ≥T, it is determined to be the key transmission node of cascade effect of the local energy scarcity risk.

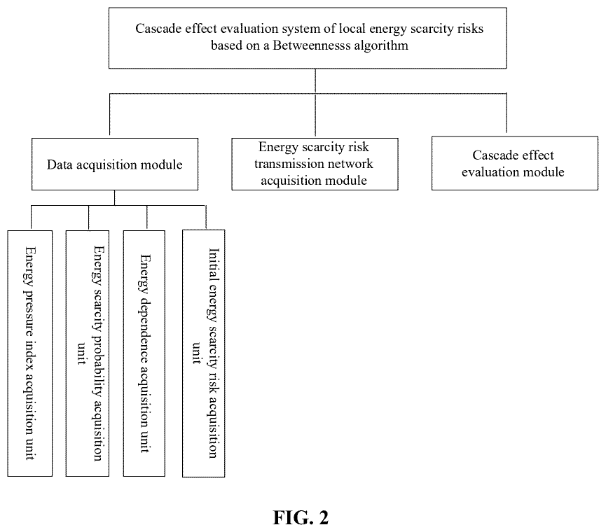

As shown in FIG. 2, the cascade effect evaluation system for local energy scarcity risks based on a Betweenness algorithm, including a data acquisition module, an energy scarcity risk transmission network acquisition module and a cascade effect evaluation module;

where the data acquisition module includes an energy pressure index acquisition unit, an energy scarcity probability acquisition unit, an energy dependence acquisition unit, and an initial energy scarcity risk acquisition unit;
the energy pressure index acquisition unit is configured to calculate the energy pressure index of each region;
the energy scarcity probability acquisition unit is configured to calculate the energy scarcity probability of each region;
the energy dependence acquisition unit is configured to calculate the energy dependence based on various sectors in each region;
the initial energy scarcity risk acquisition unit is configured to calculate the energy scarcity risk of each sector in each region;
the virtual energy scarcity risk transmission network acquisition module is configured to build a virtual energy scarcity risk transmission network;
the cascade effect evaluation module is configured to determine the key transmission nodes of the cascade effect of local energy scarcity risks based on the Betweenness algorithm.

An electronic device, including a memory, a processor, and a computer program stored in the memory and capable of running on the processor, implements the cascade effect evaluation method for the local energy scarcity risks when the processor executes the computer program.

A computer readable storage medium, the computer readable storage medium stores a computer program, when the computer program is executed by the processor, the cascade effect evaluation method for the energy scarcity risks is realized.

This study examines China's provinces and cities as research subjects, covering 31 provincial-level regions (excluding Tibet, Taiwan, Macao, and Hong Kong). Based on 2017 input-output table data, each province and city comprises 42 industrial sectors. The dataset is currently the most up-to-date available for the year 2017. Using the local energy scarcity risk cascade propagation assessment method outlined in Example 1, the local energy scarcity risk and its cascade effects were calculated according to the algorithms and formulas specified in each step. The results are as follows:

The top five sectors across regions with the highest local energy scarcity risk are: Hebei-Metal Smelting and Rolling Processing Products (CNY 140.8 billion), Jiangsu-Metal Smelting and Rolling Processing Products (CNY 89.4 billion), Sichuan-Transportation, Warehousing, and Postal Services (CNY 64.2 billion), Sichuan-Metal Smelting and Rolling Processing Industry (CNY 60.7 billion), and Guangdong-Transportation, Warehousing, and Postal Services (CNY 59.2 billion).

The key transmission nodes in the cascade effect of local energy scarcity risk are: Hebei-Metal Smelting and Rolling Processing Products (CNY 109.3 billion), Jiangsu-Metal Smelting and Rolling Processing Products (CNY 107.0 billion), Shandong-Metal Smelting and Rolling Processing Products (CNY 96.1 billion), Sichuan-Chemical Products (CNY 70.5 billion), and Henan-Metal Smelting and Rolling Processing Products (CNY 70.4 billion).

The energy scarcity risk values provided in brackets in the above results are relative values rather than actual economic losses; they reflect the relative magnitude of potential economic losses. By comparing these relative values, the key transmission nodes in the cascade effect of local energy scarcity risk can be identified.

Previous studies have identified both donors and recipients in the cascade effect of energy scarcity risk. Major donors include: Hebei-Metal Smelting and Rolling Processing Products (CNY 272.9 billion), Jiangsu-Metal Smelting and Rolling Processing Products (CNY 181.9 billion), Henan-Metal Smelting and Rolling Processing Products (CNY 118.3 billion), Sichuan-Metal Smelting and Rolling Processing Products (CNY 107.6 billion), and Guangxi-Metal Smelting and Rolling Processing Products (CNY 93.3 billion). Major recipients include: Sichuan-Water Production and Supply (CNY 92.8 billion), Yunnan-Water Production and Supply (CNY 59.6 billion), Chongqing-Water Production and Supply (CNY 52.6 billion), Hunan-Water Production and Supply (CNY 52.6 billion), and Jiangsu-Electrical Machinery and Equipment (CNY 50.7 billion).

In contrast to earlier research, which focused primarily on donors and recipients, this study also identifies intermediate key transmission nodes in the cascade effect of energy scarcity risk. These include: Shandong-Metal Smelting and Rolling Processing Products (CNY 96.1 billion), Sichuan-Chemical Products (CNY 70.5 billion), Jiangsu-Electrical Machinery and Equipment (CNY 69.2 billion), Shandong-Chemical Products (CNY 65.7 billion), and Jiangsu-Metal Products (CNY 64.8 billion).

These results identify all key transmission nodes in the cascade effect of energy scarcity risk, clarifying the full set of critical junctures in its propagation. This provides a foundation for a more systematic and comprehensive assessment of the cascade effect of energy scarcity risk and offers data support for formulating more effective strategies to enhance the resilience of the entire trade network in response to energy scarcity risks. Identifying intermediate key nodes also facilitates early intervention in risk propagation, thereby helping to prevent potentially severe impacts.

Specifically, for the key transmission nodes in the cascade effect of energy scarcity risk, regional sectors may adopt the following measures: First, improve energy efficiency and increase energy supply to ensure stable supply chain performance amid supply-demand imbalances. Second, enhance diversification of upstream supply chain dependencies and adjust trade strategies to reduce reliance on a single energy source, thereby mitigating vulnerability to energy scarcity. Additionally, strengthen cooperation and communication with key supply chain nodes, and leverage technology and information-sharing platforms to improve responsiveness to supply chain disruptions, enabling more efficient risk management and emergency response.

Finally, it should be noted that the above embodiments are intended solely to explain the technical methodology of the invention and not to limit it. Although the invention has been described in detail with reference to preferred embodiments, those skilled in the art should understand that modifications or substitutions to the technical methodology of the invention are still possible. Such modifications or equivalent replacements should not cause the adapted technical methodology to depart from the spirit and scope of the invention's technical approach.

What is claimed is:

1. A cascade effect evaluation method for local energy scarcity risks based on a Betweennesss algorithm comprising the following steps:
S1, obtaining an energy pressure index of each region and an energy dependence of each sector, calculating an energy scarcity probability according to the energy pressure index, and calculating an initial energy scarcity risk according to the energy scarcity probability and the energy dependence of each sector;
S2, combining the initial energy scarcity risk with a multi-regional input-output model to construct a virtual energy scarcity risk transmission network;
S3, based on a Betweenness algorithm, evaluating and identifying a key transmission node of a cascade effect of local energy scarcity risks in the virtual energy scarcity risk transmission network;
wherein combining the initial energy scarcity risk with the multi-regional input-output model to construct the virtual energy scarcity risk transmission network, specifically comprises:
an expression using a Ghosh inverse matrix to evaluate a spread of virtual energy scarcity risks, wherein:
$$U = {\hat{E} ( I - B )}^{- 1} ;$$
where U denotes a propagation matrix of the virtual energy scarcity risks, in which element
$${u}_{m , i}^{n , j}$$
denotes a cascade effect of sector m in region i on sector n in region j;
E is a row vector, where each element denotes the initial energy scarcity risk of each sector in each region, and expression Ê is a process of diagonalization of vector E;
denotes matrix (I−B)⁻¹ is the Ghosh inverse matrix, where each element
$${g}_{m , i}^{n , j}$$
denotes an output quantity of sector n in region j caused by an accumulation of unit products produced by sector m in region i, B denotes a direct output coefficient matrix in the multi-regional input-output model, and I denotes a unit matrix;
wherein, after Taylor expansion of the Ghosh inverse matrix, the energy scarcity risk is decomposed into different production levels:
$$G = {( I - B )}^{- 1} = I + B + {B}^{2} + {B}^{3} + … ;$$
$$U = \hat{E} ( I + B + {B}^{2} + {B}^{3} + … ) = \hat{E} I + \hat{E} B + \hat{E} {B}^{2} + \hat{E} {B}^{3} + … ;$$
where a supply chain path starts from sector m in region i, passes through (r₁, r₂, . . . rₖ) of sector k, and ends in sector q in this region, an expression of the cascade effect generated by the path is:
$$P ( m , \vert q \vert {r}_{1} , {r}_{2} , … {r}_{k} ) = {E}_{m , i} {b}_{m {r}_{1}} {b}_{{r}_{1} {r}_{2}} … {b}_{{r}_{k} q} ;$$
where P (m, |q|r₁, r₂, . . . rₖ) denotes a weight of supply chain path (m→r₁→r₂→ . . . →rₖ→q);
E_{m,i} denotes the initial energy scarcity risk in sector m in region i;
element bₘᵣ_{₁}bᵣ_{₁}ᵣ_{₂} . . . bᵣ_{ₖ}_{q} belongs to the elements in matrix B;
the virtual energy scarcity risk transmission network is composed of supply chain paths;
wherein based on the Betweenness algorithm, evaluating and identifying the key transmission node of the cascade effect of local energy scarcity risks in the virtual energy scarcity risk transmission network, specifically comprising:
$${b}_{i} = {\sum }_{m = 1}^{n} {\sum }_{q = 1}^{n} {\sum }_{k = 1}^{∞} ( {t}_{k} P ( m , \vert q \vert {r}_{1} , {r}_{2} , … {r}_{k} ) ) ;$$
where bᵢ denotes a Betweenness of sector i;
n denotes a number of sectors in the virtual energy scarcity risk transmission network;
tₖ denotes an occurrence time of sector i between the two ends of the supply chain path (m→r₁→r₂→ . . . →rₖ→q);
wherein a total weight of the supply chain path through sector i is defined as bᵢ(l₁, l₂), and an expression of bᵢ(l₁, l₂) is:
$$\begin{matrix}{b}_{i} ( {l}_{1} , {l}_{2} ) = {\sum }_{1 \leq {r}_{1} , … {r}_{{l}_{1}} \leq n} {\sum }_{1 \leq {j}_{1} , {j}_{l 2} \leq n} ( {E}_{{r}_{1}} {b}_{{r}_{1} {r}_{2}} … {b}_{{r}_{{l}_{1}} i} {b}_{i {j}_{1}} … {b}_{{j}_{{l}_{2} - 1} {j}_{{l}_{2}}} ) \\ = {\sum }_{1 \leq {r}_{1} , … {r}_{{l}_{1}} \leq n} ( {E}_{{r}_{1}} {b}_{{r}_{1} {r}_{2}} … {b}_{{r}_{{l}_{1}} i} {\sum }_{1 \leq {j}_{1} , … {j}_{l 2} \leq n} ( {b}_{i {j}_{1}} … {b}_{{j}_{{l}_{2} - 1} {j}_{{l}_{2}}} ) ) \\ = {\sum }_{1 \leq {r}_{1} , … {r}_{{l}_{1}} \leq n} ( {E}_{{r}_{1}} {b}_{{r}_{1} {r}_{2}} … {b}_{{r}_{{l}_{1}} i} {\sum }_{1 \leq {j}_{1} , … {j}_{l 2} \leq n} ( {b}_{i {j}_{1}} … {b}_{{j}_{{l}_{2} - 1} {j}_{{l}_{2}}} ) ) \\ = {( E {B}^{{l}_{1}} )}_{i} {( {B}^{{l}_{2}} e )}_{i} \\ = E {B}^{{l}_{1}} {J}_{i} {B}^{{l}_{2}} e\end{matrix}$$
where l₁ denotes a number of upstream sectors of sector i, l₂ denotes a number of downstream sectors of sector i. l₁ and l₂ are all integers greater than or equal to 1; Jᵢ denotes a matrix that being 1 at element (i,i) and being 1 at other elements; e denotes a unit column vector e with a size of n×1, all elements of e are equal to 1; T=GB=BG=B+B²+B³+ . . . , wherein a Betweenness expression of sector i is:
$$\begin{matrix}{b}_{i} = {\sum }_{{l}_{1} = 1}^{∞} {\sum }_{{l}_{2} = 1}^{∞} {b}_{i} ( {l}_{1} , {l}_{2} ) = {\sum }_{{l}_{1} = 1}^{∞} {\sum }_{{l}_{2} = 1}^{∞} ( E {B}^{{l}_{1}} {J}_{i} {B}^{{l}_{2}} e ) \\ = {\sum }_{{l}_{1} = 1}^{∞} ( E {B}^{{l}_{1}} {J}_{i} {\sum }_{{l}_{2} = 1}^{∞} ( {B}^{{l}_{2}} e ) ) \\ = ( {\sum }_{{l}_{1} = 1}^{∞} ( E {B}^{{l}_{1}} ) ) {J}_{i} ( {\sum }_{{l}_{2} = 1}^{∞} ( {B}^{{l}_{2}} e ) ) \\ = E ( {\sum }_{{l}_{1} = 1}^{∞} {B}^{{l}_{1}} ) {J}_{i} ( {\sum }_{{l}_{2} = 1}^{∞} {B}^{{l}_{2}} ) e \\ = {ETJ}_{i} Te\end{matrix}$$
where n×n matrix T=GB is composed of the Ghosh inverse matrix G and the direct output coefficient matrix B, element tᵢⱼ in the matrix denotes a direct and indirect output of sector j generated by a single output of sector i;
where the Betweenness values bᵢ of all nodes are summed and averaged to obtain the mean b̅:
$$\overline{b} = \frac{{\sum }_{i = 1}^{n} {b}_{i}}{n}$$
where n denotes a total number of nodes in the network;
wherein, through a mean multiple method, a screening threshold T of key nodes is set, that is, a multiple of b̅: T=λ·b̅
where λ denotes a multiple factor, it is set to 2;
wherein the Betweenness value and the threshold value of each sector in regional nodes are compared; and if a node has a Betweenness value bᵢ≥T, it is determined to be the key transmission node of cascade effect of the local energy scarcity risk.

2. The cascade effect evaluation method for local energy scarcity risks based on the Betweennesss algorithm according to claim 1, wherein an expression for calculating the energy pressure index is:
$$E P {I}_{i} = \frac{{\sum }_{k = 1}^{h} {CE}_{i}^{k}}{{\sum }_{k = 1}^{h} {SE}_{i}^{k}}$$
where
$$S {E}_{i}^{k} = D {E}_{i}^{k} + {IME}_{i}^{k} - {EXE}_{i}^{k} ,$$
EPIᵢ denotes an energy pressure index of region i, SEᵢ^{k} denotes a supply of a k-th energy in region i,
$$C {E}_{i}^{k}$$
denotes a consumption of the k-th energy in region i, 1≤k≤h, h denotes an energy type,
$$D {E}_{i}^{k}$$
denotes a production of the k-th energy in region i,
$$M {E}_{i}^{k}$$
denotes an import of the k-th energy in region i, and
$${EXE}_{i}^{k}$$
denotes an export of the k-th energy in region i.

3. The cascade effect evaluation method for local energy scarcity risks based on the Betweennesss algorithm according to claim 1, wherein an expression of energy scarcity probability is:
$${ESP}_{i} = {f}_{ESP} ( {EPI}_{i} ; σ ) = E ( {Y}_{i} ) ; where$$
$${Y}_{i} = \{ \begin{matrix}0 & {X}_{i} \geq 1 \\ 1 - {X}_{i} & {X}_{i} < 1\end{matrix} \} , {X}_{i} ∼ Log normal ( {μ}_{i} , {σ}^{2} ) , {μ}_{i} . = log \frac{1}{{EPI}_{i}} , {ESP}_{i}$$
denotes an energy scarcity probability in region i, E(Yᵢ) denotes an expected value of Yᵢ, Yᵢ denotes an energy scarcity in region i on each space-time unit, Xᵢ obeys a lognormal distribution and denotes a ratio of energy supply and consumption in region i within each space-time unit, μᵢ is a variance, parameter σ is a standard deviation, equal to 1.

4. The cascade effect evaluation method for local energy scarcity risks based on the Betweennesss algorithm according to claim 3, wherein an expression of energy dependence of each sector is:
$${EDL}_{m , i} = {f}_{EDL} ( {EI}_{m , i} ; α ) = \frac{1}{1 + {e}^{- α {EI}_{m , i}^{int}} ( \frac{1}{0.001} - 1 )}$$
where
$${EI}_{m , i} = \frac{{\sum }_{k = 1}^{10} {EC}_{m , i}^{k}}{{x}_{m , i}} ,$$
EDL_{m,i} denotes an energy dependence of sector m in region i,
$${EC}_{m , i}^{k}$$
denotes a consumption of the k-th energy of sector m in region i, and EI_{m,i} denotes an energy consumption intensity of sector m in region i, EI_{m,i} is equal to a sum
$${\sum }_{k = 1}^{10} {EC}_{m , i}^{k}$$
of 10 energy consumptions of sector m in region i divided by a total output x_{m,i}, α is a cut-off parameter of ED_{m,i}, a value is set to 2.

5. The cascade effect evaluation method for local energy scarcity risks based on the Betweennesss algorithm according to claim 4, wherein an expression of the initial energy scarcity risk is:
$${IESR}_{m , i} = {ESP}_{i} \times {EDL}_{m , i} \times {x}_{m , i}$$
where IESR_{m,i} denotes an initial energy scarcity risk of sector m in region i; ESPᵢ denotes an energy scarcity probability in region i; EDL_{m,i} denotes an energy dependence of sector m in region i; x_{m,i} denotes a total output of sector m in region i.

6. A cascade effect evaluation system for local energy scarcity risks based on a Betweenness algorithm, comprising a data acquisition module, an energy scarcity risk transmission network acquisition module and a cascade effect evaluation module;
wherein the data acquisition module comprises an energy pressure index acquisition unit, an energy scarcity probability acquisition unit, an energy dependence acquisition unit, and an initial energy scarcity risk acquisition unit;
wherein the energy pressure index acquisition unit is configured to calculate the energy pressure index of each region;
the energy scarcity probability acquisition unit is configured to calculate the energy scarcity probability of each region;
the energy dependence acquisition unit is configured to calculate the energy dependence based on various sectors in each region;
the initial energy scarcity risk acquisition unit is configured to calculate the energy scarcity risk of each sector in each region;
the virtual energy scarcity risk transmission network acquisition module is configured to build a virtual energy scarcity risk transmission network;
the cascade effect evaluation module is configured to determine the key transmission nodes of the cascade effect of local energy scarcity risks based on the Betweenness algorithm;
wherein an expression of using a Ghosh inverse matrix to evaluate a spread of virtual energy scarcity risks is:
$$U = {\hat{E} ( I - B )}^{- 1} ;$$
where U denotes a propagation matrix of the virtual energy scarcity risks, in which element
$${u}_{m , i}^{n , j}$$
denotes a cascade effect of sector m in region i on sector n in region j;
E is a row vector, where each element denotes the initial energy scarcity risk of each sector in each region, and expression Ê is a process of diagonalization of vector E;
denotes matrix (I−B)⁻¹ is the Ghosh inverse matrix, where each element
$${g}_{m , i}^{n , j}$$
denotes an output quantity of sector n in region j caused by an accumulation of unit products produced by sector m in region i, B denotes a direct output coefficient matrix in the multi-regional input-output model, and I denotes a unit matrix;
wherein, after Taylor expansion of the Ghosh inverse matrix, the energy scarcity risk is decomposed into different production levels:
$$G = {( I - B )}^{- 1} = I + B + {B}^{2} + {B}^{3} + … ;$$
$$U = \hat{E} ( I + B + {B}^{2} + {B}^{3} + … ) = \hat{E} I + \hat{E} B + \hat{E} {B}^{2} + \hat{E} {B}^{3} + … ;$$
where a supply chain path starts from sector m in region i, passes through (r₁, r₂, . . . rₖ) of sector k, and ends in sector q in this region, an expression of the cascade effect generated by the path is:
$$P ( m , \vert q \vert {r}_{1} , {r}_{2} , … {r}_{k} ) = {E}_{m , i} {b}_{m {r}_{1}} {b}_{{r}_{1} {r}_{2}} … {b}_{{r}_{k} q} ;$$
where P(m, |q|r₁, r₂, . . . rₖ) denotes a weight of supply chain path (m→r₁→r₂→ . . . rₖ→q);
E_{m,i} denotes the initial energy scarcity risk in sector m in region i;
element bₘᵣ_{₁}bᵣ_{₁}ᵣ_{₂} . . . bᵣ_{ₖ}_{q} belongs to the elements in matrix B;
the virtual energy scarcity risk transmission network is composed of supply chain paths;
wherein based on the Betweenness algorithm, evaluating and identifying the key transmission node of the cascade effect of local energy scarcity risks in the virtual energy scarcity risk transmission network, specifically comprising:
$${b}_{i} = {\sum }_{m = 1}^{n} {\sum }_{q = 1}^{n} {\sum }_{k = 1}^{∞} ( {t}_{k} P ( m , \vert q \vert {r}_{1} , {r}_{2} , … {r}_{k} ) )$$
where bᵢ denotes a Betweenness of sector i;
n denotes a number of sectors in the virtual energy scarcity risk transmission network;
tₖ denotes an occurrence time of sector i between the two ends of the supply chain path (m→r₁→r₂→ . . . →rₖ→q);
wherein a total weight of the supply chain path through sector i is defined as bᵢ(l₁, l₂), and an expression of bᵢ(l₁, l₂) is:
$$\begin{matrix}{b}_{i} ( {l}_{1} , {l}_{2} ) = {\sum }_{1 \leq {r}_{1} , … {r}_{{l}_{1}} \leq n} {\sum }_{1 \leq {j}_{1} , … {j}_{t 2} \leq n} ( {E}_{{r}_{1}} {b}_{{r}_{1} {r}_{2}} … {b}_{{r}_{{l}_{1} i}} {b}_{{ij}_{1}} … {b}_{{j}_{{l}_{2} - 1} {j}_{{l}_{2}}} ) \\ = {\sum }_{1 \leq {r}_{1} , … {r}_{{l}_{1}} \leq n} ( {E}_{{r}_{1}} {b}_{{r}_{1} {r}_{2}} … {b}_{{r}_{{l}_{1}} i} {\sum }_{1 \leq {j}_{1} , … {j}_{l 2} \leq n} ( {b}_{{ij}_{1}} … {b}_{{j}_{{l}_{2} - 1} {j}_{{l}_{2}}} ) ) \\ = ( {\sum }_{1 \leq {r}_{1} , … {r}_{{l}_{1}} \leq n} ( {E}_{{r}_{1}} {b}_{{r}_{1} {r}_{2}} … {b}_{{r}_{{l}_{1}} i} ) ) ( {\sum }_{1 \leq {j}_{1} , … {j}_{t 2} \leq n} ( {b}_{{ij}_{1}} … {b}_{{j}_{{l}_{2} - 1} {j}_{{l}_{2}}} ) ) \\ = {( {EB}^{{l}_{1}} )}_{i} {( {B}^{{l}_{2}} e )}_{i} \\ = {EB}^{{l}_{1}} {J}_{i} {B}^{{l}_{2}} e\end{matrix}$$
where l₁ denotes a number of upstream sectors of sector i, l₂ denotes a number of downstream sectors of sector i. l₁ and l₂ are all integers greater than or equal to 1; Jᵢ denotes a matrix that being 1 at element (i,i) and being 1 at other elements; e denotes a unit column vector e with a size of n×1, all elements of e are equal to 1; T=GB=BG=B+B²+B³+ . . . , wherein a Betweenness expression of sector i is:
$${b}_{i} = {\sum }_{{l}_{1} = 1}^{∞} {\sum }_{{l}_{2} = 1}^{∞} {b}_{i} ( {l}_{1} , {l}_{2} ) = {\sum }_{{l}_{1} = 1}^{∞} {\sum }_{{l}_{2} = 1}^{∞} ( {EB}^{{l}_{1}} {J}_{i} {B}^{{l}_{2}} e ) = {\sum }_{{l}_{1} = 1}^{∞} ( {EB}^{{l}_{1}} {J}_{i} {\sum }_{{l}_{2} = 1}^{∞} ( {B}^{{l}_{2}} e ) ) = ( {\sum }_{{l}_{1} = 1}^{∞} ( {EB}^{{l}_{1}} ) ) {J}_{i} ( {\sum }_{{l}_{2} = 1}^{∞} ( {B}^{{l}_{2}} e ) ) = E ( {\sum }_{{l}_{1} = 1}^{∞} {B}^{{l}_{1}} ) {J}_{i} ( {\sum }_{{l}_{2} = 1}^{∞} {B}^{{l}_{2}} ) e = {ETJ}_{i} Te$$
where n×n matrix T=GB is composed of the Ghosh inverse matrix G and the direct output coefficient matrix B, element tᵢⱼ in the matrix denotes a direct and indirect output of sector j generated by a single output of sector i;
where the Betweenness values bᵢ of all nodes are summed and averaged to obtain the mean b̅:
$$\overline{b} = \frac{{\sum }_{i = 1}^{n} {b}_{i}}{n}$$
where n denotes a total number of nodes in the network;
wherein, through a mean multiple method, screening threshold T of key nodes is set, that is, a multiple of b̅: T=λ·b̅
where λ denotes a multiple factor, it is set to 2;

7. An electronic device, comprising a memory, a processor, and a computer program stored in the memory and capable of running on the processor, which implements the cascade effect evaluation method for the local energy scarcity risks according to claim 1 when the processor executes the computer program.

8. A computer readable storage medium, wherein the computer readable storage medium stores a computer program, and when the computer program is executed by the processor, the cascade effect evaluation method for the energy scarcity risks according to claim 1 is realized.
